(19) United States
(12) Patent Application Publication
(10) Pub. No.: US 2014/0258419 A1
(43) Pub. Date: Sep. 11, 2014

(54) SHARING CONTENT ACROSS MODALITIES

(71) Applicant: MOTOROLA MOBILITY LLC, Libertyville, IL (US)

(72) Inventor: Albert F. Osterloh, Burlingame, CA (US)

(73) Assignee: MOTOROLA MOBILITY LLC, Libertyville, IL (US)

(21) Appl. No.: 13/784,857

(22) Filed: Mar. 5, 2013

(51) Int. Cl. H04L 12/58

(52) U.S. Cl. CPC H04L 51/32
USPC 709/206

(57) ABSTRACT

When a communication is sent, it is automatically directed to a utility or application (herein called a “modality”) that the intended recipient prefers to use for communications of this type. The recipient's preference may be explicit or implicit. That is, the recipient may state, in a profile, his preference that photographs be received into, say, a particular social-networking account. Implicitly, it may be noticed that the intended recipient frequently reviews voice mails received on his mobile phone but only rarely checks his home voice-mail box. Then, a voice mail for this recipient may be preferentially sent to his mobile phone's voice-mail box. Different content types may be sent to different modalities, as the recipient's preferences dictate.

### TECHNICAL FIELD

The present disclosure is related generally to media-content delivery and, more particularly, to social communications.

### BACKGROUND

People are sharing more and more information electronically. They send e-mails and short text messages to friends and colleagues. Photographs, videos, and sound clips are often posted to social-networking sites.

Not only is the amount of information sharing proliferating, so are the kinds of applications that people use to access shared information.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is an overview of a representative environment in which the present techniques may be practiced;

FIG. 2 is a generalized schematic of some of the devices of FIG. 1;

FIG. 3 is a flowchart of a representative method for sending content;

FIG. 4 is a flowchart of a representative method for receiving content; and

FIG. 5 is a flowchart of a representative method usable by a server to transmit content.

### DETAILED DESCRIPTION

Turning to the drawings, wherein like reference numerals refer to like elements, techniques of the present disclosure are illustrated as being implemented in a suitable environment. The following description is based on embodiments of the claims and should not be taken as limiting the claims with regard to alternative embodiments that are not explicitly described herein.

The proliferation of information-sharing applications, while enabling new and interesting modes of communications, presents its own problems. To keep in touch, a typical user today may have to check for voice messages on his phones (work, home, and mobile), check one or more e-mail accounts, and visit a few social-networking sites. If a sender wishes his message to be noticed quickly by its intended recipients, then he has to choose which information-sharing application to send the message to, and that choice may vary from recipient to recipient, may vary from one content type to another, and may vary with each recipient's current context.

Aspects of the present disclosure address these problems. When a communication is sent, it is automatically directed to a utility or application (herein called a “modality”) that the intended recipient prefers to use for communications of this type. The recipient's preference may be explicit or implicit. That is, the recipient may state, in a profile, his preference that photographs be received into, say, a particular social-networking account. Implicitly, it may be noticed that the intended recipient frequently reviews voice mails received on his mobile phone but only rarely checks his home voice-mail box. Then, a voice mail for this recipient may be preferentially sent to his mobile phone's voice-mail box. Different content types may be sent to different modalities, as the recipient's preferences dictate.

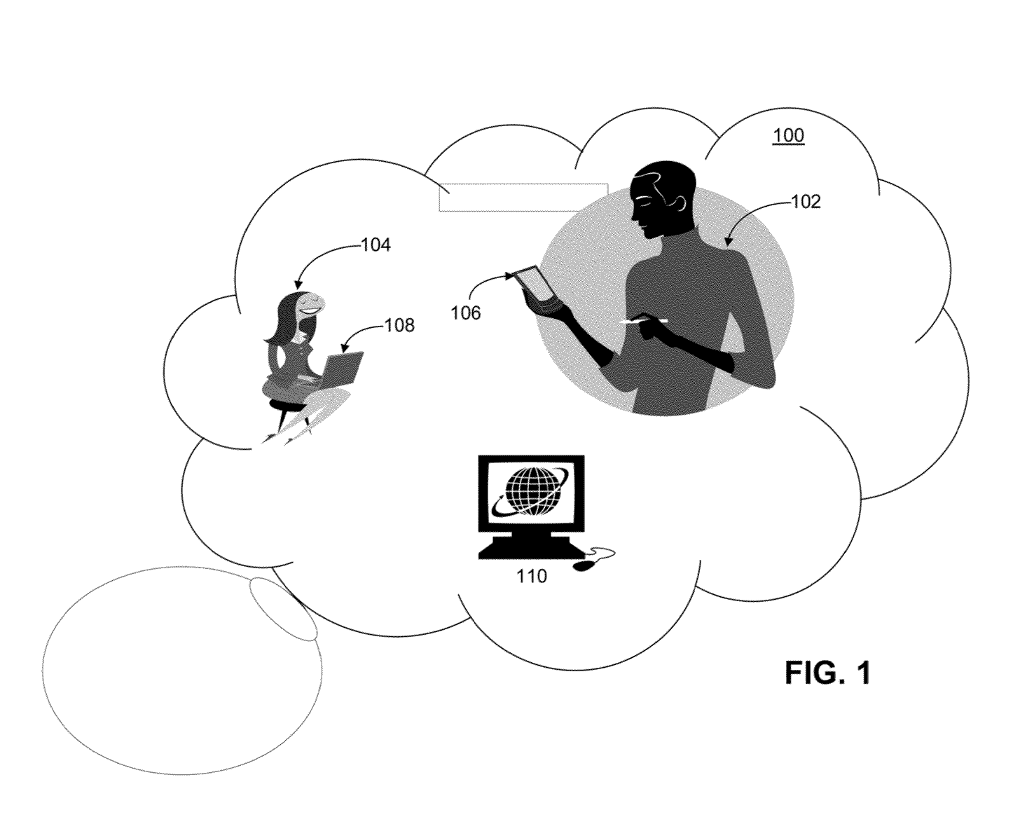

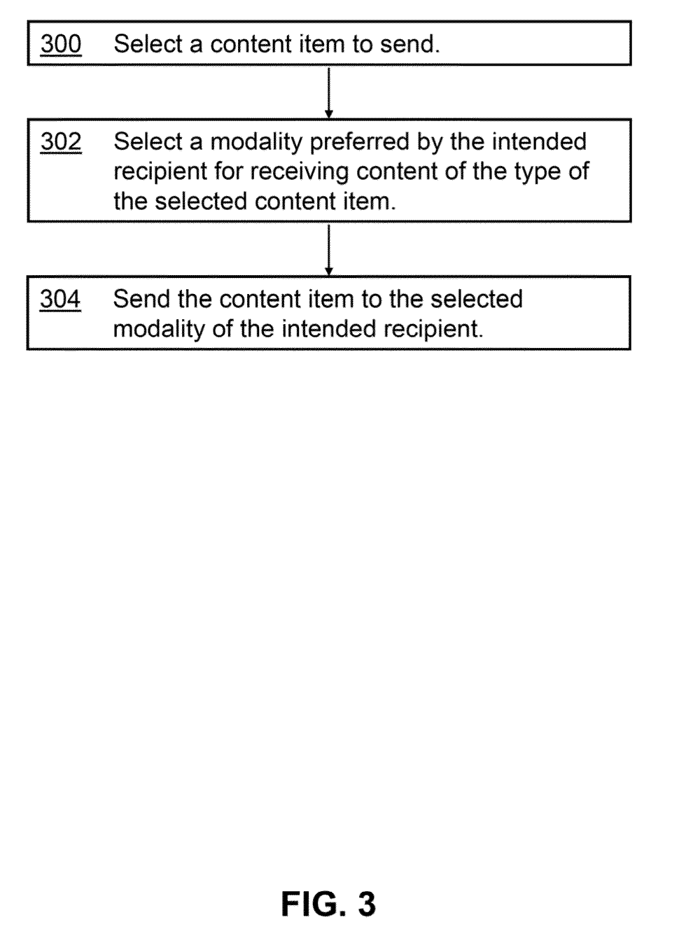

Consider the communications environment 100 of FIG. 1. The user 102 wishes to send some content to his friend 104. Technically speaking, he wishes to send a content item from his communications device 106 to her device 108. The user 102 is interested in getting the content across so that his friend 104 will see it, but his intended recipient 104 may use multiple modalities for viewing received content and may access those modalities through multiple devices 108 (although only one such device 108 is shown in FIG. 1). As discussed in greater detail below with reference to FIGS. 3 through 5, aspects of the present disclosure help the user 102 by automatically directing the content he wishes to send to a modality favored by his friend 104 for receiving content of that type.

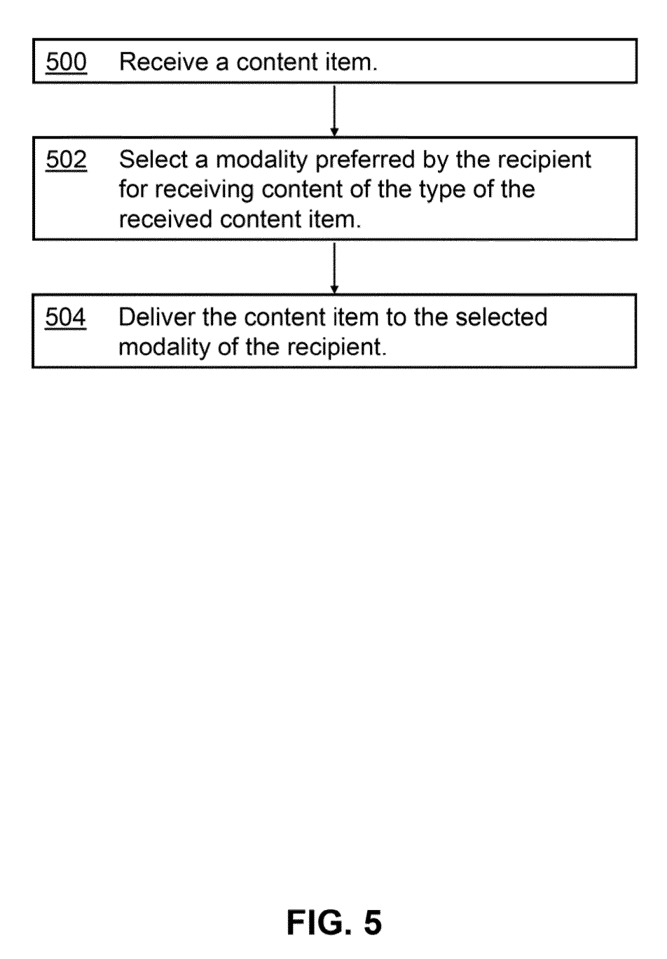

The function of the optional content server 110 is discussed below with reference to FIG. 5.

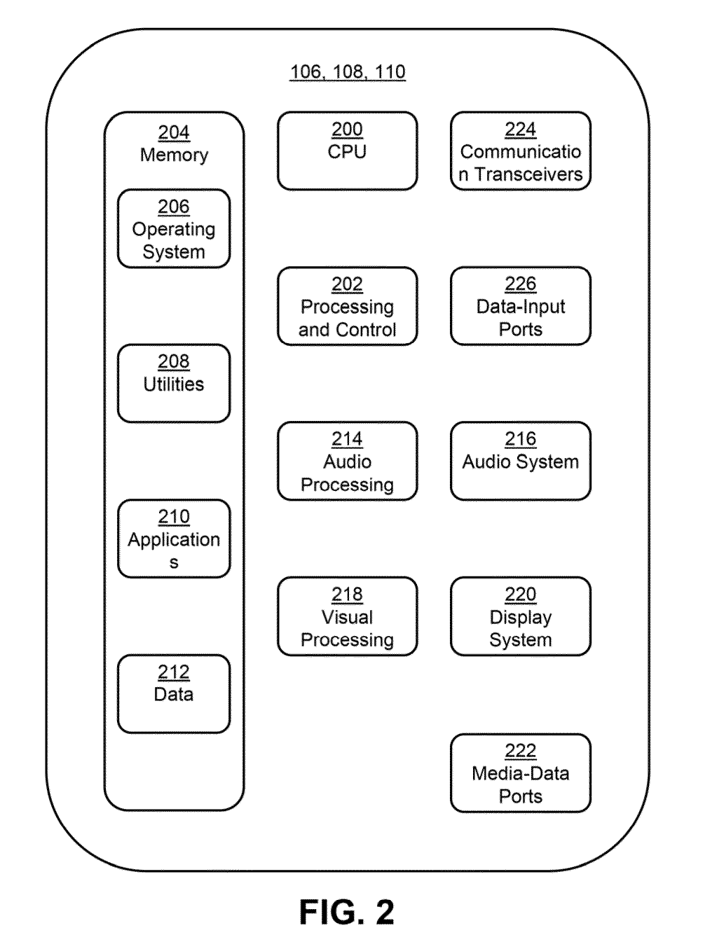

FIG. 2 shows the major components of a representative electronics device 106, 108, 110. The device 106, 108, 110 could be a personal electronics device (such as a smart phone, tablet, personal computer, or gaming console), a set-top box, or a compute server. It could even be a plurality of servers working together in a coordinated fashion.

The CPU 200 of the electronics device 106, 108, 110 includes one or more processors (i.e., any of microprocessors, controllers, and the like) or a processor and memory system which processes computer-executable instructions to control the operation of the device 106, 108, 110. In particular, the CPU 200 supports aspects of the present disclosure as illustrated in FIGS. 3 through 5, discussed below. The device 106, 108, 110 can be implemented with a combination of software, hardware, firmware, and fixed-logic circuitry implemented in connection with processing and control circuits, generally identified at 202. Although not shown, the device 106, 108, 110 can include a system bus or data-transfer system that couples the various components within the device 106, 108, 110. A system bus can include any combination of different bus structures, such as a memory bus or memory controller, a peripheral bus, a universal serial bus, and a processor or local bus that utilizes any of a variety of bus architectures.

The electronics device 106, 108, 110 also includes one or more memory devices 204 that enable data storage, examples of which include random-access memory, non-volatile memory (e.g., read-only memory, flash memory, EPROM, and EEPROM), and a disk storage device. A disk storage device may be implemented as any type of magnetic or optical storage device, such as a hard disk drive, a recordable or rewriteable disc, any type of a digital versatile disc, and the like. The device 106, 108, 110 may also include a mass-storage media device.

The memory system 204 provides data-storage mechanisms to store device data 212, other types of information and data, and various device applications 210. An operating system 206 can be maintained as software instructions within the memory 204 and executed by the CPU 200. The device applications 210 may also include a device manager, such as any form of a control application or software application. The utilities 208 may include a signal-processing and control module, code that is native to a particular component of the electronics device 106, 108, 110, a hardware-abstraction layer for a particular component, and so on.

The electronics device 106, 108, 110 can also include an audio-processing system 214 that processes audio data and controls an audio system 216 (which may include, for example, speakers). A visual-processing system 218 processes graphics commands and visual data and controls a display system 220 that can include, for example, a display screen. The audio system 216 and the display system 220 may include any devices that process, display, or otherwise render audio, video, display, or image data. Display data and audio signals can be communicated to an audio component or to a display component via a radio-frequency link, S-video link, High-Definition Multimedia Interface, composite-video link, component-video link, Digital Video Interface, analog audio connection, or other similar communication link, represented by the media-data ports 222. In some implementations, the audio system 216 and the display system 220 are components external to the device 106, 108, 110. Alternatively (e.g., in a cellular telephone), these systems 216, 220 are integrated components of the device 106, 108, 110.

The electronics device 106, 108, 110 can include a communications interface which includes communication transceivers 224 that enable wired or wireless communication. Example transceivers 224 include Wireless Personal Area Network radios compliant with various IEEE 802.15 standards, Wireless Local Area Network radios compliant with any of the various IEEE 802.11 standards, Wireless Wide Area Network cellular radios compliant with 3GPP standards, Wireless Metropolitan Area Network radios compliant with various IEEE 802.16 standards, and wired Local Area Network Ethernet transceivers.

The electronics device 106, 108, 110 may also include one or more data-input ports 226 via which any type of data, media content, or inputs can be received, such as user-selectable inputs (e.g., from a keyboard, from a touch-sensitive input screen, or from another user-input device), messages, music, television content, recorded video content, and any other type of audio, video, or image data received from any content or data source. The data-input ports 226 may include USB ports, coaxial-cable ports, and other serial or parallel connectors (including internal connectors) for flash memory, storage disks, and the like. These data-input ports 226 may be used to couple the device 106, 108, 110 to components, peripherals, or accessories such as microphones and cameras.

The sending method of FIG. 3 begins in step 300 where the user 102 selects a content item that he wises to send. The selected content item can be of any type. It may be a text message or a social-networking post. It may be short like an SMS message, web address, or a link or long like a captured video.

The sender 102 also specifies an intended recipient for this content item. The recipient may be specified as a person 104 or as a particular device 108. The user 102 may select multiple content items and multiple intended recipients in step 300, but for clarity's sake, the present discussion assumes that he selects only one of each.

In step 302, one of the recipient's intended modalities is selected for receiving the content item selected in step 300. In some situations, the intended recipient 104 explicitly states her preferred modality for a given type of content. For example, she may state in a publicly accessible profile that she does not wish to receive social e-mails in her work e-mail account but rather would prefer that such content be sent to a personal e-mail account. Or she may state that while she is happy to receive video content, she prefers to receive that content via a file-transfer application that stores the content rather than receiving it directly to a social-networking site.

The selection of step 302 may also be based on implicitly derived information. The known art of recommender systems can be applied here. Information gathered about the intended recipient's use of different modalities can be analyzed and codified into a behavioral model. If this recipient 104 has set up a social-networking page but never accesses it, for example, then it might be decided that this modality should not be selected in step 302. As is known, the frequency and recency of behavioral observations may be important. The recipient 104 may, for example, have recently purchased a smart phone with a large screen, and she now often views image information on that phone while in the past she only viewed images on her laptop computer.

The modality selection of step 302 can include a selection of a particular device 108 associated with the intended recipient 104. Context may be important here. It may be known (from behavioral observations) that during work hours she is much more likely to respond to a tweet sent to her work cellphone rather than one sent to her personal phone.

In step 304, the content item is sent to the modality selected in step 302. If possible, the response of the user 104 to this content item is noted and is used to inform the behavioral model used in step 302. If, for example, the user 104 received but never accessed the content item, then the modality selected in step 302 may not have been the best one.

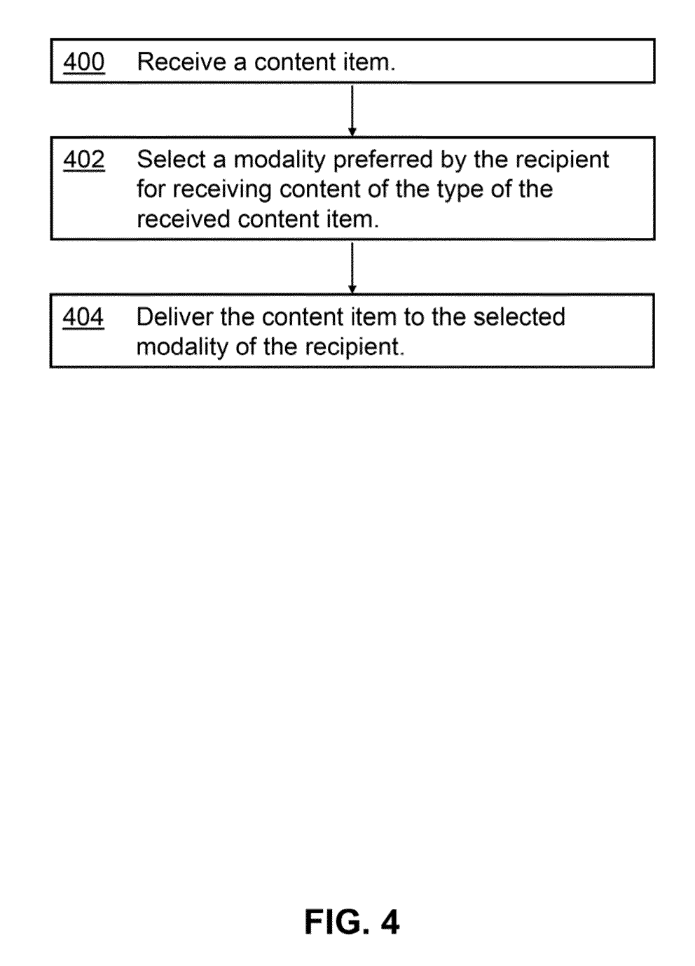

FIG. 4 presents a method for receiving a content item. The content item is received to a particular modality in step 400.

The received content item is analyzed in step 402, and an appropriate modality is selected. Any or all of the techniques discussed above in relation to step 302 of FIG. 3 may be used here. However, because step 402 is performed on a device 108 controlled by the intended recipient 104, this step 402 may have access to better preference information and may be able to make a better choice than could the sending device 106.

In general, this step 402 is an alternative to step 302 of FIG. 3, not its complement. That is to say, in general the modality selection would be performed on the sending device 106 or on the receiving device 108, but not both. However, situations can arise where modality selection is performed on both devices 106, 108. For example, the sender's modality selection of step 302 can decide to send the content item to a social-networking site. The receiving modality selection of step 402 can review that choice and override it or refine it by sending the content item to another social-networking site preferred by the recipient 104.

In step 404, the received content item is delivered to the selected modality.

The method of FIG. 5 looks remarkably similar to the method of FIG. 4. However, the method of FIG. 5 is intended to be performed by a content server 110 rather than by a receiving device 108, and this method, therefore, has different implications. In step 500, the content server 110 receives the content item. A preferred receiving modality is selected in step 502 (using any of the techniques discussed above in relation to step 302 of FIG. 3), and the content item is sent to the selected modality in step 504. The content server 110 is not directly tied to either the sending device 106 or to any particular receiving device 108 of the intended recipient 104. Thus, it is free to direct the content item to any of the recipient's devices 108. That is, by performing the method of FIG. 5, the content 110 can become a “universal address” for all of the devices and modalities used by the recipient 108. A sender 102 need not perform the modality selection of step 302 but could just send the content item to a universal address for the recipient 104 as hosted by the content server 110. The content server 110 then delivers the content item appropriately.

In view of the many possible embodiments to which the principles of the present discussion may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. A method for sending a content item from a sending communications device to an intended recipient, the method comprising:
selecting, by the sending communications device from a plurality of receiving modalities used by the intended recipient, one of the modalities as a modality preferred by the intended recipient for receiving an item of a type of the content item; and
sending, from the sending communications device to the selected modality of the intended recipient, the content item.

2. The method of claim 1 wherein the content item comprises an element selected from the group consisting of: an SMS, an MMS, a social-networking post, a text message, a file, a link to a file, an address, and a directory.

3. The method of claim 1 wherein the selected modality comprises an element selected from the group consisting of: an e-mail application, a social-networking site, a media-rendering application, a web browser, and a file-transfer application.

4. The method of claim 1 wherein selecting a modality is based, at least in part, on a recent frequency of use by the intended recipient of the selected modality.

5. The method of claim 1 wherein selecting a modality is based, at least in part, on a stated preference of the intended recipient.

6. The method of claim 1 wherein selecting a modality comprises selecting a receiving communications device.

7. A sending communications device configured for sending a content item to an intended recipient, the sending communications device comprising:
a communications interface; and
a processor operatively connected to the communications interface and configured for:
selecting, from a plurality of receiving modalities used by the intended recipient, one of the modalities as a modality preferred by the intended recipient for receiving an item of a type of the content item; and
sending, via the communications interface to the selected modality of the intended recipient, the content item.

8. The sending communications device of claim 7 wherein the device is selected from the group consisting of: a personal communications device, a mobile telephone, a personal digital assistant, a tablet computer, a gaming controller, a computer, a set-top box, a compute server, and a coordinated group of compute servers.

9. A method for a content server to send a content item to an intended recipient, the method comprising:
receiving, by the content server from a sending communications device distinct from the content server, the content item;
selecting, by the content server from a plurality of receiving modalities used by the intended recipient, one of the modalities as a modality preferred by the intended recipient for receiving an item of a type of the content item; and
sending, from the content server to the selected modality of the intended recipient, the content item.

10. The method of claim 9 wherein the content item comprises an element selected from the group consisting of: an SMS, an MMS, a social-networking post, a text message, a file, a link to a file, an address, and a directory.

11. The method of claim 9 wherein the selected modality comprises an element selected from the group consisting of: an e-mail application, a social-networking site, a media-rendering application, a web browser, and a file-transfer application.

12. The method of claim 9 wherein selecting a modality is based, at least in part, on a recent frequency of use by the intended recipient of the selected modality.

13. The method of claim 9 wherein selecting a modality is based, at least in part, on a stated preference of the intended recipient.

14. The method of claim 9 wherein selecting a modality comprises selecting a receiving communications device.

15. A content server configured for sending a content item to an intended recipient, the content server comprising:
a communications interface configured for receiving, from a sending communications device distinct from the content server, the content item; and
a processor operatively connected to the communications interface and configured for:
selecting, from a plurality of receiving modalities used by the intended recipient, one of the modalities as a modality preferred by the intended recipient for receiving an item of a type of the content item; and
sending, via the communications interface to the selected modality of the intended recipient, the content item.

16. The content server of claim 15 wherein the server is selected from the group consisting of: a personal communications device, a mobile telephone, a personal digital assistant, a tablet computer, a gaming controller, a computer, a set-top box, a compute server, and a coordinated group of compute servers.

17. A method for a receiving communications device to receive a content item for an intended recipient, the method comprising:
receiving, by the receiving communications device from a device distinct from the receiving communications device, the content item;
selecting, by the receiving communications device from a plurality of receiving modalities used by the intended recipient, one of the modalities as a modality preferred by the intended recipient for receiving an item of a type of the content item; and
delivering, by the receiving communications device to the selected modality of the intended recipient, the content item.

18. The method of claim 17 wherein the content item comprises an element selected from the group consisting of: an SMS, an MMS, a social-networking post, a text message, a file, a link to a file, an address, and a directory.

19. The method of claim 17 wherein the selected modality comprises an element selected from the group consisting of: an e-mail application, a social-networking site, a media-rendering application, a web browser, and a file-transfer application.

20. The method of claim 17 wherein selecting a modality is based, at least in part, on a recent frequency of use by the intended recipient of the selected modality.

21. The method of claim 17 wherein selecting a modality is based, at least in part, on a stated preference of the intended recipient.

22. A receiving communications device configured for receiving a content item for an intended recipient, the receiving communications device comprising:
a communications interface configured for receiving, from a device distinct from the receiving communications device, the content item; and
a processor operatively connected to the communications interface and configured for:
selecting, from a plurality of receiving modalities used by the intended recipient, one of the modalities as a modality preferred by the intended recipient for receiving an item of a type of the content item; and
delivering, to the selected modality of the intended recipient, the content item.

23. The receiving communications device of claim 22 wherein the device is selected from the group consisting of: a personal communications device, a mobile telephone, a personal digital assistant, a tablet computer, a gaming controller, a computer, a set-top box, a compute server, and a coordinated group of compute servers.
